(19) United States
(12) Patent Application Publication
(10) Pub. No.: US 2026/0195555 A1
(43) Pub. Date: Jul. 9, 2026

(54) Method and system for recognizing and/or reading a barcode for postal items

(71) Applicant: SICK AG, Waldkirch (DE)

(72) Inventors: Jonathan STEINBUCH, Denzlingen (DE); Julian ZIMMER, Freiburg (DE)

(21) Appl. No.: 19/438,858

(22) Filed: Jan. 2, 2026

(30) Foreign Application Priority Data
Jan. 8, 2025 (JP) 25150765.3

(51) Int. Cl. G06K 7/14; G06V 10/25; G06V 10/44; G06V 10/56; G06V 10/98; G06V 30/424

(52) U.S. Cl. CPC G06K 7/1413; G06V 10/25; G06V 10/44; G06V 10/56; G06V 10/993; G06V 30/424

(57) ABSTRACT

A method for recognizing and/or reading a barcode, in particular for postal items, from image data about the barcode, includes: determining at least one bar height parameter and a position of a first bar of a plurality of bars of the barcode; estimating at least one barcode height parameter of the barcode based on the bar height parameter of the first bar; starting from the position of the first bar in a first direction, determining at least one bar height parameter and a position of an adjacent second bar of the plurality of bars of the barcode; checking the estimated barcode height parameter based on the bar height parameter of the second bar; and assigning a bar type to each of the bars based on the determined bar height parameter of the respective bar and based on the estimated barcode height parameter.

The invention relates to a method and a system for recognizing and/or reading a barcode, preferably using bar height position-encoded barcode symbologies, e.g. POSTNET, PLANET, Intelligent Mail Barcode and/or Mailmark, in particular for postal items, from image data about the barcode.

Barcodes, in particular for postal items, can be recognized and/or read in image data recorded by means of cameras. An industrial process can then be controlled based on the recognized and/or read barcode. For example, by means of a recognition and/or reading of a barcode applied to a postal item, a conveyor belt can be controlled to forward the postal item for an internal goods movement and/or to a destination area.

When recognizing and/or reading a barcode, there is a need to provide a reliable reading even under difficult conditions, such as corrugations, distortions and/or soiling of the barcode.

Known systems are often based on computationally intensive image processing steps, such as image rotations, which can increase the computing effort overall.

The invention is based on the object of making methods and systems for recognizing and/or reading barcodes more robust and/or more efficient.

A method and a system having the features of the independent claims are provided to satisfy the object.

The method according to the invention for recognizing and/or reading a barcode, in particular for postal items, from image data about the barcode, comprises: determining at least one bar height parameter and a position of a first bar of a plurality of bars of the barcode, wherein the bar height parameter preferably comprises a bar height and/or at least one end point in the longitudinal bar direction; estimating, in particular initially estimating, at least one barcode height parameter of the barcode based on the bar height parameter of the first bar, wherein the barcode height parameter preferably comprises a barcode height, a position of a clock track, an upper barcode height position and/or a lower barcode height position; starting from the position of the first bar in a first direction, determining at least one bar height parameter and a position of an adjacent, in particular directly adjacent, second bar of the plurality of bars of the barcode; checking the estimated barcode height parameter based on the bar height parameter of the second bar; and assigning a bar type to each of the bars based on the determined bar height parameter of the respective bar and based on the estimated barcode height parameter.

The invention is based on the idea of checking, in particular adjusting and/or refining, the estimated barcode height parameter, based on which a bar type is assigned to the bars, in the case of a progressive detection of the bars. In this respect, the first bar represents the starting point for the detection of the barcode; the barcode does not already have to be completely detected at the start. Overall, the robustness, in particular with respect to corrugations, distortions and/or soiling of the barcode, and the efficiency of the method for recognizing and/or reading barcodes can be increased compared to conventional methods.

The first bar can be assigned a bar type based on the initially estimated barcode height parameter and the second bar can be assigned a bar type based on the checked estimated barcode height parameter. Alternatively or additionally, the first bar can be assigned a bar type based on the checked estimated barcode height parameter. The assignment of a bar type to the first bar can be checked and, if necessary, retroactively adjusted based on the checked estimated barcode height parameter.

It is understood that the method can be carried out, in particular automatically, by means of an (electronic) processing apparatus or computing device.

The image data can be recorded and/or obtained by means of a camera, for example, as a 2D gray scale image or a 2D color value image.

The bar height parameter of the first and/or second bar can additionally comprise a longitudinal bar direction of the first or the second bar. The longitudinal bar direction of a bar can, for example, be defined by its two end points in the longitudinal bar direction. Alternatively, the longitudinal bar direction can, in particular initially, be defined as an orthogonal of the direction of progression (i.e. preferably as an orthogonal of the first direction). As described later, the longitudinal bar direction can (also retrospectively) be determined (or adjusted) via a linear regression.

The clock track corresponds to a region of the bars that is present in each of the bars. The height of the clock track can, for example, be one third of the barcode height. The clock track is present between the lower barcode height position and the upper barcode height position.

In the (initial) estimation of the barcode height parameter based on the bar height parameter of the first bar, the barcode height can, for example, be set to the bar height of the first bar. Alternatively or additionally, the upper and/or lower barcode height position can be set to the corresponding end point of the first bar.

During the checking of the estimated barcode height parameter, the (initially) estimated barcode height parameter can, for example, be confirmed, the estimated barcode height parameter can be re-estimated based on the bar height parameter of the first bar and based on the bar height parameter of the second bar, e.g. as the mean value or median value of the two bar height parameters, or the barcode height parameter can be re-estimated solely based on the bar height parameter of the second bar.

The assignment of a bar type to the bars can take place progressively, i.e. from bar to bar and/or as soon as the respective bar has been detected. Alternatively or additionally, the assignment of a bar type to the bars can take place after a complete detection of all the bars of the barcode. In this way, the bar types present in the barcode can be recognized, in particular progressively, and added to a plurality of bar types. In the case of a progressive detection of the bars and/or after a complete detection of all the bars, a barcode type can, for example, be recognized based on the detected plurality of bar types and/or an initially assumed barcode type can be checked based on the detected bar types.

An example of a barcode type is a so-called “four-state” barcode type in which so-called “ascenders”, “descenders”, “full bars” and “trackers” can be present as bar types. With such a four-state barcode type, the clock track is located in the middle of the barcode, i.e. in the middle of the “full bars” that extend from the lower up to the upper barcode height position. A “tracker” can substantially have the height of the clock track and is located in the middle of the barcode. An “ascender” is oriented from the clock track to the upper barcode height position. In contrast, a “descender” is oriented from the clock track to the lower barcode height position. A further example of a barcode type is a so-called “two-state” barcode type in which “trackers” and “full bars” can be present as bar types. The clock track and thus also the trackers are in this respect located either at the upper or the lower barcode height position, i.e. on the upper or lower side of the barcode, depending on the position of the barcode in a reading region.

According to one embodiment, the first direction is parallel to a direction of the barcode and/or orthogonal to the longitudinal bar direction of the first bar. The direction (i.e. rough direction) of the barcode can be known by preprocessing the image data.

According to one embodiment, the first direction is checked. In this respect, the first direction can be adjusted and/or redetermined based on a longitudinal bar direction of the second bar, e.g. as an orthogonal to the longitudinal bar direction of the second bar.

According to one embodiment, starting from the position of the second bar in the, preferably checked, in particular adjusted and/or redetermined, first direction, a bar height parameter and a position of a third bar of the plurality of bars of the barcode are determined, said third bar being adjacent, in particular directly adjacent, to the second bar. In other words, it can be an iterative process; for the further sequence of the procedure, the third bar (for the next iteration) i.e. represents the second bar, so to speak, and the second bar represents the first bar, so to speak. The estimated barcode height parameter can be rechecked based on the bar height parameter of the third bar and a bar type can be assigned to the third bar based on the determined bar height parameter of the third bar and based on the (rechecked) estimated barcode height parameter. The previously assigned bar types can additionally be checked. In particular, a bar type can be reassigned to the first and/or second bar based on the rechecked estimated barcode height parameter and based on the respective bar height parameter, in particular if the estimated barcode height parameter was adjusted during the rechecking and/or a previously undetected bar type was assigned to the third bar. The first direction can be checked again. In this respect, the first direction can be readjusted and/or redetermined based on a longitudinal bar direction of the third bar, e.g. as an orthogonal to the longitudinal bar direction of the third bar.

According to one embodiment, the estimated barcode height parameter is improved and/or refined during the checking based on the bar height parameter of the second bar.

According to one embodiment, during the checking of the estimated barcode height parameter, the estimated barcode height parameter is confirmed if the bar height parameter of the second bar is higher or lower than the estimated barcode height parameter, taking into account a tolerance range.

According to one embodiment, the barcode height parameter is re-estimated solely based on the bar height parameter of the second bar if the bar height parameter of the second bar is higher than the estimated barcode height parameter, taking into account the tolerance range.

According to one embodiment, the barcode height parameter is re-estimated based on the bar height parameter of the first bar and based on the bar height parameter of the second bar, e.g. as the arithmetic mean value or median value of the two bar height parameters, if the bar height parameter of the second bar lies at the estimated barcode height parameter, taking into account the tolerance range.

According to one embodiment, the method further comprises preprocessing the image data to determine a position of at least one point on the barcode and a (rough) direction of the barcode, wherein the first bar is detected by scanning the image data, in particular from pixel to pixel, along a line that is defined based on the determined position of the point on the barcode and the direction of the barcode; by recognizing edge transitions, in particular as light-to-dark transitions or dark-to-light transitions, along the line and determining their respective position and orientation; and by defining the first bar based on a first pair of edge transitions oriented oppositely to one another, said first pair being selected from the determined edge transitions, i.e. a pair of a consecutive light-to-dark transition and dark-to-light transition. The scanned line can have a start point and an end point. The start point can correspond to the determined point on the barcode. The position of the first bar can then, for example, be determined as the mean value between the two edge transitions. The determination of the edge transitions or edge points on the scanned line together with their orientation (light-to-dark transition or dark-to-light transition) can take place by means of a Sobel filter. If the subsequent measurement of the first bar fails, another pair of edge transitions oriented oppositely to one another can be selected in order to define the first bar. If no suitable pair of edge transitions is recognized, a slightly offset line (for example, offset in parallel by at least one pixel) can be scanned until a suitable pair of edge transitions is recognized or a maximum number of attempts is reached, i.e. a maximum number of lines has been scanned. If the detection of the first bar is unsuccessful, an error signal can be output.

According to one embodiment, the position of the clock track in the longitudinal bar direction is assumed to be in the middle of the bars. Alternatively, the clock track is assumed at one of the two ends of the bars. Preferably, in the initial estimation based on the bar height parameter of the first bar, the position of the clock track in the longitudinal bar direction is assumed to be in the middle of the first bar. In other words, a four-state barcode type is preferably initially assumed.

According to one embodiment, the image data comprise pixels, wherein the pixels corresponding to the bars have a gray value equal to or less than a gray value limit value or a color value in a (previously defined) color value range.

According to one embodiment, during the determination of the bar height parameter of the second bar, and also during the determination of the bar height parameter of each further bar, image errors in the respective bar are ignored when it is found that pixels (and in particular at least a specific number of pixels) with a gray value equal to or less than the gray value limit value or with a color value within the color value range are present in an image region above the image error and below or at the estimated upper barcode height position and/or that pixels with a gray value equal to or less than the gray value limit value or with a color value within the color value range are present in an image region below the image error and above or at the estimated lower barcode height position. In other words, image errors whose pixels can have a gray value or a color that corresponds to the background of the barcode can be ignored when it is found that bar pixels are present above and/or below the image error. In this way, the robustness of the method can be increased.

In particular, image errors are only ignored if the image errors lie completely between the estimated lower and upper barcode height position. In this way, e.g. printed elements outside the barcode can additionally be prevented from being incorrectly interpreted as a barcode, whereby the robustness of the method can be further increased.

According to one embodiment, the estimated upper and/or lower barcode height position is/are projected from the first bar in the first direction.

According to one embodiment, a plausibility of the projection of the estimated upper and/or lower barcode height position is checked based on the previously assigned bar types.

The checking of the plausibility can in particular comprise changing the barcode height parameter for the second bar or for subsequent bars. In this respect, the barcode height parameter can be actively adjusted (and not just projected following the course of the barcode). For example, if the previous assumption (of the barcode height parameters and the bar types) has become implausible due to the last-measured bar. In such a case, the backtracking, which will be explained in even more detail later, can be triggered, wherein the previous bar types can possibly be redetermined.

According to one embodiment, the bar height parameter of the second bar comprises an upper and a lower end point in the longitudinal bar direction.

It is understood that the second bar can at least substantially have the same size as the first bar, but can also be larger or smaller. The handling of these various cases is discussed in the following paragraphs.

According to one embodiment, during the checking of the estimated barcode height parameter, the estimated upper and lower barcode height position are confirmed if the upper end point of the second bar is lower than the projected upper barcode height position and/or if the lower end point of the second bar is higher than the projected lower barcode height position. The comparison of the end points with the previously estimated barcode height positions can in this respect take place while considering a tolerance range, i.e. the estimated upper and lower barcode height position are confirmed if the upper end point of the second bar is lower, i.e. significantly lower, than the projected upper barcode height position, taking into account the tolerance range, and/or if the lower end point of the second bar is higher, i.e. significantly higher, than the projected lower barcode height position, taking into account the tolerance range.

According to one embodiment, during the checking of the estimated barcode height parameter, the upper and/or lower barcode height position is/are re-estimated based on the upper or lower end point of the second bar if the upper end point of the second bar is higher than the projected upper barcode height position or if the lower end point of the second bar is lower than the projected lower barcode height position. For example, in these cases, the lower barcode height position can be set to the lower end point of the second bar and/or the upper barcode height position can be set to the upper end point of the second bar. It is understood that the comparison of the end points of the second bar with the projected barcode height positions can also here take place while considering a tolerance range.

According to one embodiment, during the checking of the estimated barcode height parameter, the upper and/or lower barcode height position is/are re-estimated based on the upper end point of the first bar and based on the upper end point of the second bar or based on the lower end point of the first bar and based on the lower end point of the second bar if the upper end point of the second bar lies in a tolerance range around the projected upper barcode height position or if the lower end point of the second bar lies in a tolerance range around the projected lower barcode height position.

According to one embodiment, a change of a bar type from an ascender to a descender or from a descender to an ascender is assumed if the bar height of the second bar corresponds to the estimated barcode height and if the upper end point of the second bar is lower or higher than the upper barcode height position and the lower end point of the second bar is lower or higher than the lower barcode height position. This can in particular be the case if a maximum of two bar types, i.e. full bars and/or trackers, have been detected so far.

It should be clarified that the above-mentioned change of bar type is to be understood such that a descender follows an ascender, or vice versa, in the actual bar sequence. At least one of the bars can have been assumed to be a “full bar” until the aforementioned change of the bar type. Due to the offset of the iterative next bar from this bar, this assumption must be revised. As a result, it can then be determined that the bars whose type is changed must be a combination of an ascender and a descender in succession.

According to one embodiment, a bar width of the first bar is determined.

According to one embodiment, the second bar detected by estimating a bar spacing based on the bar width of the first bar and scanning at least one line parallel to the first direction and/or orthogonally to the longitudinal bar direction of the first bar until at least a second pair of edge transitions oriented oppositely to one another is detected and/or until a spacing limit value based on the estimated bar spacing is reached. The line can, for example, be scanned, starting from an edge transition of the first bar. The bar spacing can be a spacing between the centers of adjacent bars. Preferably, for all further bars, the bar spacing is estimated based on a rolling average of the previous bar spacings. The bar spacing can, for example, be estimated as a multiple of the bar width of the first bar. The bar spacing can, for example, have a value between 100% and 500%, preferably between 150% and 300%, of the bar width of the first bar, wherein values around 200%, i.e., for example, between 185% and 215%, have proven to be preferred in practice. Preferably two or more lines, and, for example, five lines distributed in the longitudinal bar direction, are scanned. The spacing limit value can be a multiple of the estimated bar spacing and preferably twice the estimated bar spacing. If the spacing limit value is reached without at least a second pair of edge transitions oriented oppositely to one another being detected, a signal can be output and/or the search for bars in the first direction can be terminated because, for example, one end of the barcode has been reached.

According to one embodiment, at least one line is scanned in a region of the estimated position of the clock track and at least one line is scanned outside the region of the estimated position of the clock track. Preferably (e.g. when assuming a four-state code), at least three lines are scanned in the region of the estimated position of the clock track, at least one line is scanned above the region of the estimated position of the clock track and at least one line is scanned below the region of the estimated position of the clock track. Alternatively, two lines on the same side of the clock track can be scanned (e.g. assuming a two-state code with a clock track disposed at the margin).

According to one embodiment, for each scanned line, a center between the edge transitions of the detected nearest pairs of edge transitions oriented oppositely to one another is determined.

According to one embodiment, the determined centers are grouped (for example “clustered”) into groups and only that group which is closest to the estimated bar spacing is used for the detection of the second bar. In this way, the centers for the detection of the second bar can be filtered, which improves the robustness.

According to one embodiment, the longitudinal bar direction of the second bar is determined based on at least two determined centers by means of a linear regression. Alternatively, the longitudinal bar direction of the first bar is defined as the longitudinal bar direction of the second bar. The latter can in particular take place if at least two centers cannot be determined for a linear regression.

According to one embodiment, the upper and/or lower end point of the second bar is/are determined with the aid of the determined longitudinal bar direction of the second bar.

According to one embodiment, for the subsequent detection of the third bar that is adjacent to the second bar, the estimated upper and/or lower barcode height position of the second bar is/are projected in a direction orthogonal to the longitudinal bar direction of the second bar. In this way, the direction for the projection of the estimated upper and/or lower barcode height position can be adjusted from bar to bar, which increases the robustness.

According to one embodiment, the second bar is verified by checking whether there are pixels, and in particular at least a predetermined number of pixels, above the upper end point of the second bar and/or below the lower end point of the second bar that have a gray value above a gray value limit value or a color value outside a color value range (i.e. belong to the background of the barcode) and/or whether a contrast of a gray value or color value of the second bar to the gray value or color value of the pixels above and/or below the upper or lower end point is equal to or greater than a contrast limit value.

An end of the barcode in the first direction can, for example, be detected based on the fact that no further adjacent bar can be detected in the first direction, in particular when scanning the line. Additionally or alternatively, an end of the barcode in the first direction can be detected based on the fact that the verification of the further bar fails.

According to one embodiment, the method comprises: repeating the determination of a bar height parameter of an adjacent bar and repeating the checking of the barcode height parameter in the, preferably iteratively checked, in particular iteratively adjusted and/or recalculated, first direction and in a, preferably iteratively checked, in particular iteratively adjusted and/or recalculated, second direction opposite the first direction until all the bars of the plurality of bars have been detected. According to an embodiment, the method further comprises assigning a bar type to each of the bars of the plurality of bars based on the determined bar height parameter of the respective bar and based on the estimated, in particular iteratively estimated, barcode height parameter. In this way, the entire barcode can be detected, starting from the detected first bar, without having to analyze the entire image data and/or without already having to completely detect the barcode at the start. Overall, the robustness and efficiency can be increased.

According to one embodiment, for the assignment of a bar type to the respective bar, a spacing of an upper and/or lower end point of the respective bar from the estimated, and in particular projected, upper or lower barcode height position is determined and the bar type is defined according to whether the determined spacing is equal to or less than a spacing limit value.

The spacing limit value is preferably set assuming a barcode type. Preferably, a four-state code is initially assumed. The assumption of the barcode can be changed later. In other words, the assignment of a bar type to the respective bar can take place based on the relative exhaustion of the estimated barcode height at the end points of the bar. Assuming a four-state barcode type, a bar that substantially fully utilizes the barcode height upwards and downwards can be determined as a “full bar”, a bar that substantially fully utilizes the barcode height only upwards or only downwards can be determined as an “ascender” or a “descender”, and a bar that utilizes the barcode height neither upwards nor downwards can be determined as a “tracker”. Assuming a two-state barcode type, a bar that substantially fully utilizes the barcode height upwards and downwards can be determined as a “full bar” and a bar that substantially fully utilizes the barcode height only upwards or only downwards can be determined as a “tracker”.

According to one embodiment, the assignment of the bar types to the bars, assuming the barcode type, is checked for plausibility, wherein, if the plausibility is negated, the assignment of the bar types to the bars is checked assuming a different barcode type with at least one other spacing limit value. For the assumption of a barcode type, a normal orientation and also an upside-down orientation can be checked, in particular for four-state codes. The plausibility can, for example, be negated if the number ratio of the different bar types to one another is impossible for the initially assumed barcode type. The assignment of the bar types can then be repeated, for example, assuming a two-state code, which at least implies a different spacing limit value so that all the bars that are not nearly exhausted are determined as trackers.

According to one embodiment, the bar types differ in the bar height. Additionally or alternatively, the bar types differ in the orientation of the bars relative to the position of the clock track.

According to one embodiment, on an adjustment of the estimated barcode height parameter and/or on an assignment of a bar type that has not yet been assigned, the assignment of a bar type for the previously detected bars is checked and is in particular adjusted retroactively, if necessary. In other words, a so-called “backtracking” can take place.

According to one embodiment, the estimated position of the clock track is progressively checked based on the previously assigned bar types.

According to one embodiment, the method further comprises determining and/or outputting an output parameter based on the assigned bar types. The output parameter can, for example, be based on the assigned sequence of bar types, in particular the assigned sequence of bar types. Additionally or alternatively, the assigned sequence of bar types can be processed into a barcode result using known methods and can be output with the output parameter. The output parameter that has been output can be used to control an industrial process, for example to control a conveyor belt.

A further subject of the invention is a system for recognizing and/or reading a barcode, in particular for postal items, from image data about the barcode, said system comprising a camera that is configured to record image data, in particular about the barcode, and a processing apparatus that is configured, based on the image data about the barcode, to determine at least one bar height parameter and a position of a first bar of a plurality of bars of the barcode, wherein the bar height parameter preferably comprises a bar height and/or at least one end point in the longitudinal bar direction; to estimate at least one barcode height parameter of the barcode based on the bar height parameter of the first bar, wherein the barcode height parameter preferably comprises a barcode height, a position of a clock track, an upper barcode height position and/or a lower barcode height position; to determine, starting from the position of the first bar in a first direction, at least one bar height parameter and a position of an adjacent second bar of the plurality of bars of the barcode; to check the estimated barcode height parameter based on the bar height parameter of the second bar; and to assign a bar type to each of the bars based on the determined bar height parameter of the respective bar and based on the estimated barcode height parameter.

The processing apparatus can comprise a processor, a microprocessor or a server. The processing apparatus or its functions can be provided, in whole or in part, by the camera, a separate unit and/or a remote server.

The system can further comprise an illumination unit for illuminating a reading region in which the barcode is present.

It is understood that what is described with respect to the method according to the invention also applies to the system. This in particular applies to embodiments and advantages. Furthermore, it is to be understood that all the features and embodiments disclosed herein can be combined unless explicitly stated otherwise.

The invention will be described in the following purely by way of example with reference to possible embodiments and to the enclosed drawing. There are shown:

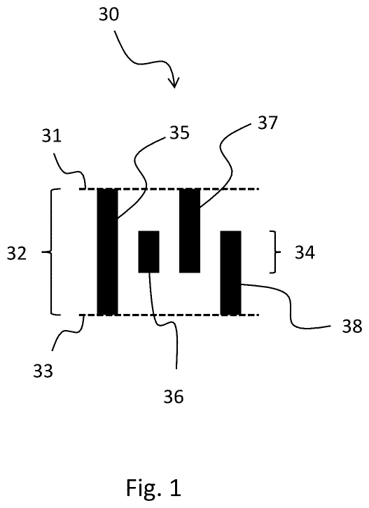

FIG. 1 a schematic representation of a barcode of a four-state barcode type;

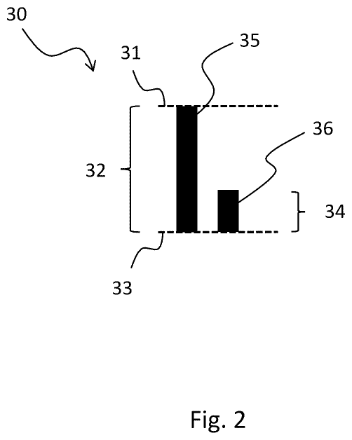

FIG. 2 a schematic representation of a barcode of a two-state barcode type;

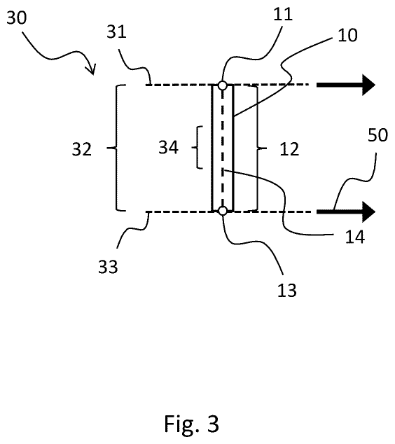

FIG. 3 a schematic representation of a first bar of a barcode;

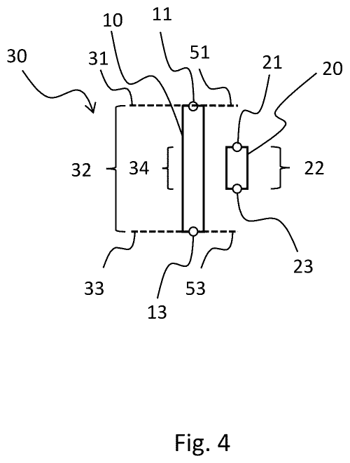

FIG. 4 a schematic representation of a second bar of a barcode;

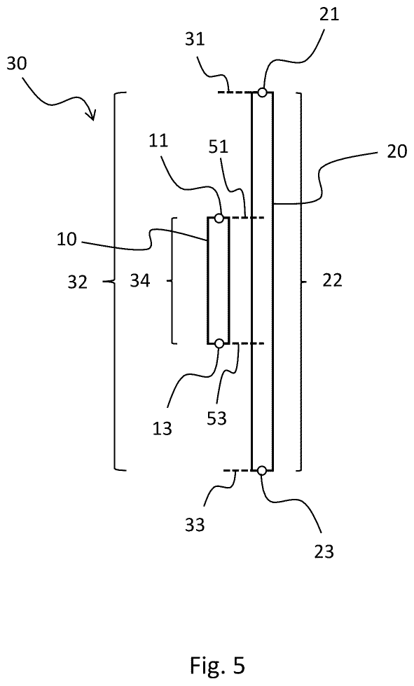

FIG. 5 a schematic representation of a second bar of a barcode;

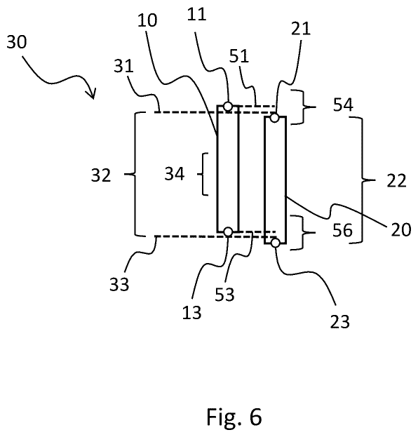

FIG. 6 a schematic representation of a second bar of a barcode;

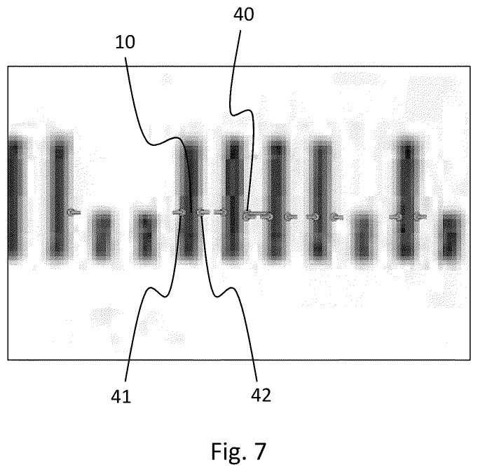

FIG. 7 a visual representation of image data about a barcode;

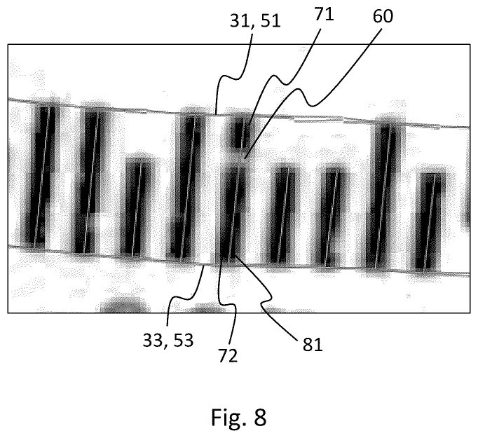

FIG. 8 a visual representation of image data about a barcode;

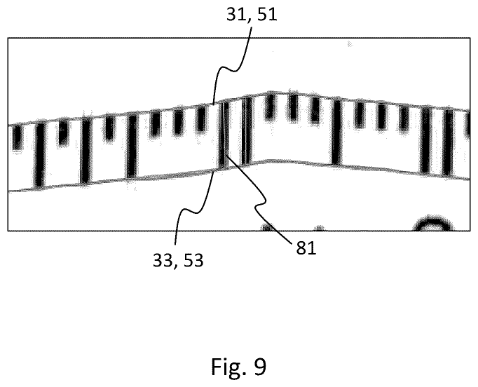

FIG. 9 a visual representation of image data about a barcode;

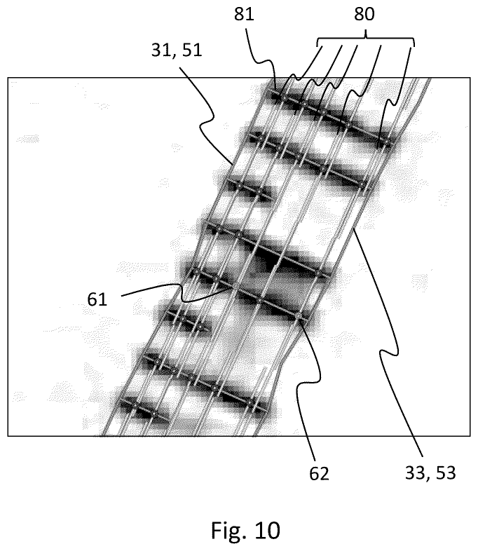

FIG. 10 a visual representation of image data about a barcode;

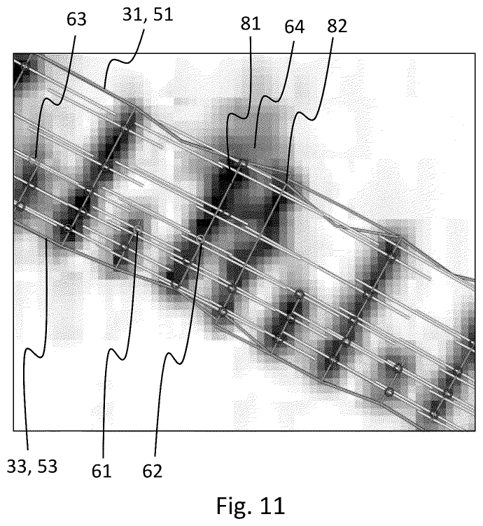

FIG. 11 a visual representation of image data about a barcode;

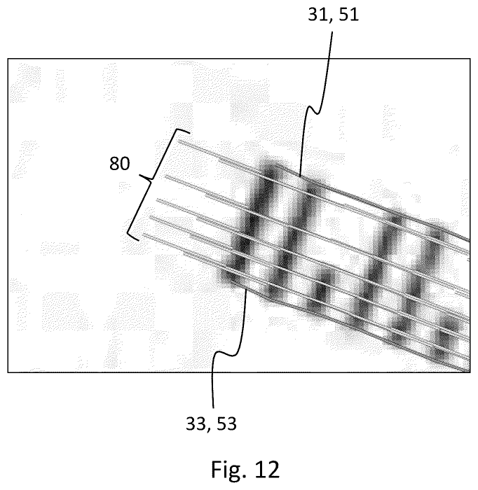

FIG. 12 a visual representation of image data about a barcode; and

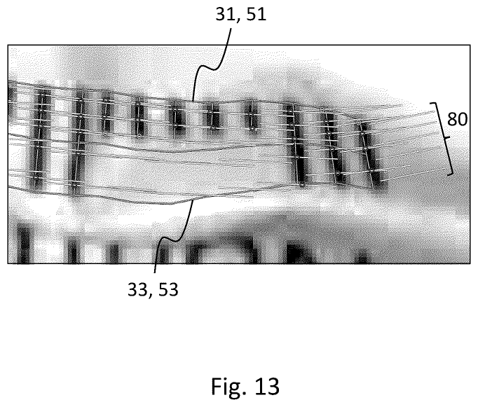

FIG. 13 a visual representation of image data about a barcode.

FIG. 1 shows a schematic representation of a barcode 30, in particular for postal items, as it can be recognized and/or read from image data by means of the procedures described herein. As shown in FIG. 1, a barcode height parameter of the barcode 30 can comprise a barcode height 32, a position of a clock track 34, an upper barcode height position 31 and/or a lower barcode height position 33.

In this respect, FIG. 1 shows a barcode 30 of a so-called four-state barcode type in which so-called full bars 35, trackers 36, ascenders 37 and descenders 38 can be present as bar types. The clock track 34 is located (viewed vertically) in the middle of the barcode 30, i.e. in the middle of the full bar 35 that extends from the lower barcode height position 33 up to the upper barcode height position 31. A tracker 36 can substantially have the height of the clock track 34 and is located in the middle of the barcode 30. An ascender 37 is oriented from the clock track 34 to the upper barcode height position 31. In contrast, a descender 38 is oriented from the clock track 34 to the lower barcode height position 33.

FIG. 2 shows a barcode 30 of a so-called two-state barcode type. As shown in FIG. 2, full bars 35 and trackers 36 can be present as bar types. The clock track 34 and thus also the trackers 36 are in this respect located at one of the two barcode height positions 31, 33, i.e. on the upper or lower side of the barcode 30, depending on the position of the barcode in a reading region.

FIG. 3 shows a schematic representation of a first bar 10 of a plurality of bars of a barcode 30, as it can be recognized and/or read from image data about the barcode 30 using a method described herein. In this respect, at least one bar height parameter and a position of the first bar 10 are initially determined, wherein the bar height parameter can comprise a bar height 12, an upper end point 11 in the longitudinal bar direction 14 and/or a lower end point 13 in the longitudinal bar direction 14. A barcode height parameter of the barcode 30 can then be estimated based on the bar height parameter of the first bar 10, wherein the barcode height parameter can comprise a barcode height 32, a position of a clock track 34, an upper barcode height position 31 and/or a lower barcode height position 33. In the (initial) estimation of the barcode height parameter based on the bar height parameter of the first bar 10, the barcode height 32 can be set to the bar height 12 of the first bar 10, the upper barcode height position 31 can be set to the upper end point 11 of the first bar 10, the lower barcode height position 33 can be set to the lower end point 13 of the first bar 10, and the position of the clock track 34 in the longitudinal bar direction can be set to the middle of the first bar 10. Starting from the position of the first bar 10 in a first direction 50, an adjacent second bar 20 of the plurality of bars of the barcode 30 can then be searched for, as shown in FIG. 4 to FIG. 6. In particular, the estimated upper and lower barcode height positions 31, 33 can be projected from the first bar 10 in the first direction 50. The first direction 50 can be parallel to a rough direction of the barcode 30, wherein the rough direction can be known by preprocessing the image data about the barcode 30. Alternatively, the first direction 50 can be orthogonal to the longitudinal bar direction 14 of the first bar 10.

As shown in FIG. 4 to FIG. 6, at least one bar height parameter and a position of the second bar 20 can be determined, wherein the bar height parameter of the second bar 20 can likewise comprise a bar height 22, an upper end point 21 in the longitudinal bar direction and a lower end point 23 in the longitudinal bar direction. The estimated barcode height parameter can then be checked based on the bar height parameter of the second bar 20.

As shown in FIG. 4, during the checking of the estimated barcode height parameter, the bar height 32 and the upper and lower barcode height position 31, 33 are not adjusted or confirmed if the upper end point 21 of the second bar 20 is (taking into account a tolerance range, and therefore significantly) lower than the projected upper barcode height position 51 and if the lower end point 23 of the second bar 20 is (taking into account a tolerance range, and therefore significantly) higher than the projected lower barcode height position 53. In this case, the bar height 22 of the second bar 20 is also significantly smaller than the estimated barcode height 32 that is subsequently not adjusted or confirmed.

As shown in FIG. 5, during the checking of the estimated barcode height parameter, the upper and lower barcode height position 31, 33 can be re-estimated solely based on the upper end point 21 or lower end point 23 of the second bar 20 if the upper end point 21 of the second bar 20 is (taking into account a tolerance range, and therefore significantly) higher than the projected upper barcode height position 51 or if the lower end point 23 of the second bar is (taking into account a tolerance range, and therefore significantly) lower than the projected lower barcode height position 53. For example, the lower barcode height position 33 can be set to the lower end point 23 of the second bar 20 and/or the upper barcode height position 31 can be set to the upper end point 21 of the second bar 20. As shown in FIG. 5, the bar height 22 of the second bar 20 can be significantly greater than the previously estimated barcode height 32 and the bar height 22 of the second bar 20 subsequently becomes the newly estimated barcode height 32.

As shown in FIG. 6, during the checking of the estimated barcode height parameter, the upper and lower barcode height position 31, 33 can be re-estimated based on the upper end point 11 of the first bar 10 and based on the upper end point 21 of the second bar 20 or based on the lower end point 13 of the first bar 10 and based on the lower end point 23 of the second bar 20, for example as the mean value between the end points of both bars, if the upper end point 21 of the second bar 20 lies in a tolerance range 54 around the projected upper barcode height position 51 or if the lower end point 23 of the second bar 20 lies in a tolerance range 56 around the projected lower barcode height position 53. The re-estimated barcode height 32 can then be the mean value of the bar height 12 of the first bar 10 and the bar height 22 of the second bar 20.

In this way, the barcode height 32 and the upper and lower barcode height positions 31, 33 can be refined and/or improved during the (iterative) checking. It is understood that the estimated position of the clock track 34 (as shown in FIG. 4 to FIG. 6) can also be checked, in particular refined and/or improved, based on the bar height parameter 21, 22, 23 of the second bar 20.

The first bar 10 and the second bar 20 can be assigned a bar type based on the relative exhaustion of the estimated barcode height positions 31, 33 or the projected barcode height positions 51, 53 at the end points 11, 12, 21, 23 of the respective bar 10, 20. For example, a spacing of the upper end point 21 and lower end point 23 of the second bar 20 from the projected upper barcode height position 51 or the projected lower barcode height position 53 can be determined and the bar type can be defined according to whether the determined spacing is equal to or less than a spacing limit value. For the example of a barcode shown in FIG. 4, assuming a four-state barcode type, the first bar 10 can be assigned the bar type “Full Bar” and the second bar 20 can be assigned the bar type “Tracker”. For the example of a barcode shown in FIG. 5, assuming a four-state barcode type, the first bar 10 can be assigned the bar type “Tracker” and the second bar 20 the bar type “Full Bar”. For the example of a barcode shown in FIG. 6, assuming a four-state barcode type, the first and second bars 10, 20 can be assigned the bar type “Tracker” or “Full Bar”, with “Full Bar” being preferred. In general, the first bar 10 can be assumed to be a full bar since this inter alia has the advantage that full bars are orientation-neutral. If, in the further course, a further bar is assigned a bar type that has not yet been assigned, the assignment of a bar type can be checked for the previously detected bars 10, 20 and can be adjusted retrospectively, if necessary. In other words, a so-called “backtracking” can take place.

The first direction 50 (as shown in FIG. 3) can be checked based on a longitudinal bar direction of the second bar 20 (as shown in FIG. 4 to FIG. 6), e.g. can be adjusted and/or redetermined as an orthogonal to the longitudinal bar direction of the second bar 20. Starting from the position of the second bar 20 in the checked, in particular adjusted and/or redetermined, first direction, an adjacent third bar can then be searched for. For the further sequence of the iterative process, the third bar then represents the second bar 20, so to speak, and the second bar 20 represents the first bar 10, so to speak.

FIG. 7 shows a visual representation of image data about a barcode and illustrates how a first bar of the barcode can be detected by preprocessing the image data. First, a position of at least one point (not shown in FIG. 7) on the barcode and a (rough) direction of the barcode are determined. The first bar 10 can be detected by scanning the image data, in particular from pixel to pixel, along a line (not shown in FIG. 7) that is defined based on the determined position of the point on the barcode and the direction of the barcode. Edge transitions 40 can be recognized as light-dark or dark-to-light transitions along the line using a Sobel filter and their respective position and orientation can be determined. The first bar 10 can be defined based on a first pair of edge transitions 41, 42 oppositely oriented to one another, said first pair being selected from the determined edge transitions, i.e. a pair of a light-to-dark transition 41 followed by a dark-to-light transition 42. The position of the first bar 10 can then, for example, be determined as the mean value between the two edge transitions 41, 42.

FIG. 8 shows a visual representation of image data about a barcode and illustrates how image errors 60 in the bars can be overcome using the procedures described herein. The image data can have pixels, wherein the pixels corresponding to the bars have a gray value equal to or less than a gray value limit value

or a color value in a color value range. During the determination of the bar height parameter 21, 22, 23 of the second bar 20, and also during the determination of the bar height parameter of each further bar, image errors 60 in the respective bar 20 can be ignored when it is found that pixels (and in particular at least a certain number of pixels) with a gray value equal to or less than the gray value limit value or with a color value within the color value range are present in an image region 71 above the image error 60 and below or at the estimated, in particular projected, upper barcode height position 31, 51 and/or that pixels with a gray value equal to or less than the gray value limit value or with a color value within the color value range are present in an image region 72 below the image error 60 and above or at the estimated, in particular projected, lower barcode height position 33, 53.

FIG. 9 shows a visual representation of image data about a barcode and illustrates as a further example how corrugations and distortions of the barcode can be managed. In FIG. 8 and FIG. 9, longitudinal bar directions of the bars are shown as lines. As described herein, not only the estimated barcode height positions 31, 33, but also the direction for their projection from bar to bar can be iteratively checked. In particular, the direction for the projection can be iteratively adjusted and/or redetermined, e.g. as an orthogonal to the longitudinal bar direction 81 of the initial bar for the projection. In this way, the robustness of the procedures described herein can be increased with respect to corrugations and distortions of the barcode.

Overlapping projections of barcode height positions 31, 33, which originate from a backtracking and the resulting redetermination of the barcode height positions 31, 33, can be seen in FIGS. 8 to 13.

FIG. 10 shows a visual representation of image data about a barcode and illustrates how the bars in the barcode can be progressively detected. First, a bar width of the first bar (not shown in FIG. 10) is determined and a bar spacing is estimated based on the bar width of the first bar. For all further bars, the bar spacing can be estimated based on a rolling average of the previous bar spacings. Starting from the first bar or an initial bar, five lines 80 distributed in the longitudinal bar direction of the first bar or the initial bar are scanned until at least a second pair of edge transitions oriented oppositely to one another is detected and/or until a spacing limit value based on the estimated bar spacing is reached. The scanned lines 80 can be orthogonal to the longitudinal bar direction 81 of the initial bar. It is understood that fewer or more than five lines can also be scanned. The spacing limit value can be twice the estimated bar spacing. In this respect, three lines in the region of the estimated position of the clock track 34 and two lines outside the region of the estimated position of the clock track 34 can be scanned. For each scanned line, a center is determined between the edge transitions of the detected nearest pairs of edge transitions oriented oppositely to one another. The determined centers are shown as circles in FIG. 10. Based on at least two determined centers, the longitudinal bar direction of a detected adjacent bar can be determined by means of a linear regression. The upper and lower end point of the adjacent bar can then be determined using the determined longitudinal bar direction. As shown in FIG. 10, even if the respective bar could not be reliably detected at the centers 61, 62 due to soiling of the barcode, the bar, and in particular its end points, can nevertheless be detected by means of a linear regression. If at least two centers per bar cannot be determined for the linear regression, the longitudinal bar direction of the initial bar can be defined as the longitudinal bar direction of the adjacent bar. The estimated upper barcode height position 31, 51 and lower barcode height position 33, 53 are iteratively checked, as described for FIG. 4 to FIG. 9, and projected from bar to bar in an iteratively checked direction that is in particular iteratively adjusted and/or redetermined based on the longitudinal bar direction of the initial bar. In particular, the longitudinal bar direction can be formed from a plurality of previous longitudinal bar directions, e.g. as a moving average. The assignment of a bar type to the bars can take place based on the projected estimated barcode height positions 31, 33, 51, 53 and the end points of the bars.

FIG. 11 shows a visual representation of image data about a barcode and illustrates as a further example how soiling of the barcode can be dealt with by means of the procedure in particular described for FIG. 10. Even if the respective bars could not be reliably detected at the centers 61, 62, 63 due to soiling of the barcode, the respective bars, in particular their end points, can nevertheless be detected by means of the linear regression. In particular, even if, due to the heavy soiling 64 in the upper region of the barcode, no suitable edge transitions, and as a result no centers, could be found in part, the longitudinal bar directions 81, 82, and as a result the end points of the respective bars, can nevertheless be determined based on the centers in the lower region of the barcode by means of a linear regression.

FIG. 12 shows a visual representation of image data about a barcode and illustrates how one end of the barcode can be found. If no further adjacent bar is detected during the scanning along the lines 80, it is assumed that the end of the barcode has been reached.

FIG. 13 shows a visual representation of image data about a barcode and illustrates as a further example how corrugations and distortions of the barcode can be managed, in particular with the aid of the procedures described for FIG. 10 to FIG. 12. Adjacent bars are detected by means of the iterative scanning of the lines 80. The assignment of the bar types takes place based on the determined end points of the detected bars and the projected estimated barcode height positions 31, 33, 51, 53. If no further adjacent bar is detected during the scanning along the lines 80, it is assumed that one end of the barcode has been reached.

1. A method for recognizing and/or reading a barcode from image data about the barcode, comprising
determining at least one bar height parameter and a position of a first bar of a plurality of bars of the barcode;
estimating at least one barcode height parameter of the barcode based on the bar height parameter of the first bar;
starting from the position of the first bar in a first direction, determining at least one bar height parameter and a position of an adjacent second bar of the plurality of bars of the barcode;
checking the estimated barcode height parameter based on the bar height parameter of the second bar; and
assigning a bar type to each of the bars based on the determined bar height parameter of the respective bar and based on the estimated barcode height parameter.

2. The method according to claim 1,
wherein the first direction is parallel to a direction of the barcode and/or orthogonal to the longitudinal bar direction of the first bar; and/or wherein the first direction is checked; and/or
wherein, starting from the position of the second bar in the first direction, a bar height parameter and a position of a third bar of the plurality of bars of the barcode are determined, said third bar being adjacent to the second bar.

3. The method according to claim 1,
wherein the bar types differ in the bar height;
wherein the bar types differ in the orientation of the bars relative to the position of the clock track;
wherein, on an adjustment of the estimated barcode height parameter and/or on the assignment of a bar type that has not yet been assigned, the assignment of a bar type for the previously detected bars is checked; and/or wherein the estimated position of the clock track is progressively checked based on the previously assigned bar types.

4. The method according to claim 1, wherein the estimated barcode height parameter is improved and/or refined during the checking based on the bar height parameter of the second bar; and/or
wherein, during the checking of the estimated barcode height parameter,
the estimated barcode height parameter is confirmed if the bar height parameter of the second bar is lower than the estimated barcode height parameter, taking into account a tolerance range,
the barcode height parameter is re-estimated solely based on the bar height parameter of the second bar if the bar height parameter of the second bar is higher than the estimated barcode height parameter, taking into account the tolerance range, and/or
the barcode height parameter is re-estimated based on the bar height parameter of the first bar and based on the bar height parameter of the second bar if the bar height parameter of the second bar lies at the estimated barcode height parameter, taking into account the tolerance range.

5. The method according to claim 1, further comprising preprocessing the image data to determine a position of at least one point on the barcode and a direction of the barcode, wherein the first bar is detected by
scanning the image data along a line that is defined based on the determined position of the point on the barcode and the direction of the barcode,
recognizing edge transitions along the line and determining their respective position and orientation, and
defining the first bar based on a first pair of edge transitions oriented oppositely to one another, said first pair being selected from the determined edge transitions.

6. The method according to claim 1, wherein the position of the clock track in the longitudinal bar direction is assumed to be in the middle of the bars or at one of the two ends of the bars.

7. The method according to claim 1,
wherein the image data have pixels, wherein the pixels corresponding to the bars have a gray value equal to or less than a gray value limit value or a color value in a color value range;
wherein, during the determination of the bar height parameter of the second bar, image errors in the respective bar are ignored when it is found
that pixels with a gray value equal to or less than the gray value limit value or with a color value within the color value range are present in an image region above the image error and below or at the estimated upper barcode height position, and/or
that pixels with a gray value equal to or less than the gray value limit value or with a color value within the color value range are present in an image region below the image error and above or at the estimated lower barcode height position.

8. The method according to claim 1,
wherein the estimated upper and/or lower barcode height position is/are projected from the first bar in the first direction;
wherein the bar height parameter of the second bar comprises an upper and a lower end point in the longitudinal bar direction;
wherein, during the checking of the estimated barcode height parameter, the estimated upper and lower barcode height position are confirmed if the upper end point of the second bar is lower than the projected upper barcode height position and/or if the lower end point of the second bar is higher than the projected lower barcode height position; and/or
wherein, during the checking of the estimated barcode height parameter, the upper and/or lower barcode height position is/are re-estimated solely based on the upper or lower end point of the second bar if the upper end point of the second bar is higher than the projected upper barcode height position or if the lower end point of the second bar is lower than the projected lower barcode height position; and/or
wherein, during the checking of the estimated barcode height parameter, the upper and/or lower barcode height position is/are re-estimated based on the upper end point of the first bar and based on the upper end point of the second bar or based on the lower end point of the first bar and based on the lower end point of the second bar if the upper end point of the second bar lies in a tolerance range around the projected upper barcode height position or if the lower end point of the second bar lies in a tolerance range around the projected lower barcode height position.

9. The method according to claim 8, wherein a change of a bar type from an ascender to a descender or from a descender to an ascender is assumed if the bar height of the second bar corresponds to the estimated barcode height and if the upper end point of the second bar is lower or higher than the upper barcode height position and the lower end point of the second bar is lower or higher than the lower barcode height position.

10. The method according to claim 1,
wherein a bar width of the first bar is determined; and
wherein the second bar is detected by estimating a bar spacing based on the bar width of the first bar and scanning at least one line parallel to the first direction and/or orthogonally to the longitudinal bar direction of the first bar until at least a second pair of edge transitions oriented oppositely to one another is detected and/or until a spacing limit value based on the estimated bar spacing is reached.

11. The method according to claim 10,
wherein at least one line is scanned in a region of the estimated position of the clock track and at least one line is scanned outside the region of the estimated position of the clock track;
wherein, for each scanned line, a center between the edge transitions of the detected nearest pairs of edge transitions oriented oppositely to one another is determined.

12. The method according to claim 1,
wherein the second bar is verified by checking whether there are pixels above the upper end point of the second bar and/or below the lower end point of the second bar that have a gray value above a gray value limit value or a color value outside a color value range and/or whether a contrast of a gray value or color value of the second bar to the gray value or color value of the pixels above and/or below the upper or lower end point is equal to or greater than a contrast limit value.

13. The method according to claim 1, comprising
repeating the determination of a bar height parameter of an adjacent bar and repeating the checking of the barcode height parameter in the first direction and in a second direction opposite the first direction until all the bars of the plurality of bars have been detected; and
assigning a bar type to each of the bars of the plurality of bars based on the determined bar height parameter of the respective bar and based on the estimated barcode height parameter.

14. The method according to claim 1, further comprising determining and/or outputting an output parameter based on the assigned bar types.

15. A system for recognizing and/or reading a barcode from image data about the barcode, said system comprising
a camera that is configured to record image data, and
a processing apparatus that is configured, based on the image data about the barcode,
to determine at least one bar height parameter and a position of a first bar of a plurality of bars of the barcode;
to estimate at least one barcode height parameter of the barcode based on the bar height parameter of the first bar;
to determine, starting from the position of the first bar in a first direction, at least one bar height parameter and a position of an adjacent second bar of the plurality of bars of the barcode;
to check the estimated barcode height parameter based on the bar height parameter of the second bar; and
to assign a bar type to each of the bars based on the determined bar height parameter of the respective bar and based on the estimated barcode height parameter.

16. The method according to claim 1, wherein the bar height parameter comprises a bar height and/or at least one end point in the longitudinal bar direction.

17. The method according to claim 1, wherein the barcode height parameter comprises a barcode height, a position of a clock track, an upper barcode height position and/or a lower barcode height position.

18. The method according to claim 2,
wherein the first direction is adjusted and/or redetermined based on a longitudinal bar direction of the second bar.

19. The method according to claim 2,
wherein, starting from the position of the second bar in the adjusted and/or redetermined first direction, a bar height parameter and a position of a third bar of the plurality of bars of the barcode are determined, said third bar being adjacent to the second bar.

20. The method according to claim 6, wherein in the initial estimation based on the bar height parameter of the first bar, the position of the clock track in the longitudinal bar direction is assumed to be in the middle of the first bar.

21. The method according to claim 8,
wherein a plausibility of the projection of the estimated upper and/or lower barcode height position is checked based on the previously assigned bar types;

22. The method according to claim 10,
wherein, for all further bars, the bar spacing is estimated based on a rolling average of the previous bar spacings.

23. The method according to claim 11,
wherein the determined centers are grouped into groups and only that group which is closest to the estimated bar spacing is used for the detection of the second bar.

24. The method according to claim 11,
wherein the longitudinal bar direction of the second bar is determined based on at least two determined centers by means of a linear regression or the longitudinal bar direction of the first bar is defined as the longitudinal bar direction of the second bar.

25. The method according to claim 11,
wherein the upper and/or lower end point of the second bar is/are determined with the aid of the longitudinal bar direction of the second bar.

26. The method according to claim 11,
wherein, for the subsequent detection of the third bar that is adjacent to the second bar, the estimated upper and/or lower barcode height position of the second bar is/are projected in a direction orthogonal to the longitudinal bar direction of the second bar.

27. The method according to claim 13, comprising
wherein, for the assignment of a bar type to the respective bar, a spacing of an upper and/or lower end point of the respective bar from the estimated, and in particular projected, upper or lower barcode height position is determined and the bar type is then defined according to whether the determined spacing is equal to or less than a spacing limit value.

28. The method according to claim 13, wherein the spacing limit value is defined assuming a barcode type.

29. The method according to claim 13, wherein the assignment of the bar types to the bars is checked for plausibility, wherein, if the plausibility is negated, the assignment of the bar types to the bars is checked assuming a different barcode type.
